(19) United States
(12) Patent Application Publication
(10) Pub. No.: US 2016/0330731 A1
(43) Pub. Date: Nov. 10, 2016

(54) DYNAMIC IMPLEMENTATION OF UPLINK MULTI-USER MULTIPLE INPUT AND MULTIPLE OUTPUT

(71) Applicant: Sprint Communications Company L.P., Overland Park, KS (US)

(72) Inventors: Chunmei Liu, Great Falls, VA (US); Krishna D. Sitaram, Chantilly, VA (US); Hemanth Balaji Pawar, Brambleton, VA (US); Pratik Kothari, Sterling, VA (US)

(21) Appl. No.: 14/702,899

(22) Filed: May 4, 2015

(51) Int. Cl. H04W 72/04; H04B 7/04

(52) U.S. Cl. CPC H04W 72/0413; H04B 7/0452

(57) ABSTRACT

Examples disclosed herein provide systems, methods, and software to dynamically provide multi-user multiple-input and multiple-output format to wireless communication devices. In one example, a method includes receiving uplink communication signals from wireless communication devices using single user MIMO format. The method further provides identifying uplink data requirements for the wireless communication devices, and determining whether the uplink data requirements meet uplink criteria. The method also includes, if the data requirements meet the uplink criteria, initiating a transition from the single user MIMO format to the multi-user MIMO format.

### TECHNICAL BACKGROUND

Wireless communication networks typically include wireless access systems with equipment such as wireless access, control, and routing nodes that provide wireless communication services for wireless communication devices. A typical wireless communication network includes systems to provide wireless access across a geographic region, with wireless coverage areas associated with individual wireless access nodes. The wireless access systems exchange user communications between wireless communication devices, service providers, and other end user devices. These user communications typically include voice calls, data exchanges, web pages, streaming media, or text messages, among other communication services.

In some communication systems, multiple input and multiple output (MIMO) may be used between the wireless access nodes and the wireless communication devices. MIMO is a method of increasing the capacity on a radio link by using multiple transmit antennas and receive antennas to exploit multipath propagation. In one example, a wireless access node, such as an eNodeB, may allocate uplink resource blocks to the various connecting wireless communication devices. To ensure that each of the devices is provided service, the eNodeB may allocate resource blocks to multiple devices using multi-user MIMO. Multi-user MIMO results in interference for the individual communications, but allows more devices to be serviced by the eNodeB at any one time. However, although more devices can be serviced using multi-user MIMO, each of the devices may be required to use undesirable amounts of battery to process the more complex scheduling requirements and interference of the MIMO configuration.

### Overview

Examples herein provide enhancements for providing uplink multiple input and multiple output format to wireless communication devices. In one example, a method includes receiving uplink communication signals from wireless communication devices using single user MIMO format. The method further provides identifying uplink data requirements for the wireless communication devices, and determining whether the uplink data requirements meet uplink criteria. The method also includes, if the data requirements meet the uplink criteria, initiating a transition from the single user MIMO format to the multi-user MIMO format.

### BRIEF DESCRIPTION OF THE DRAWINGS

FIG. 1 illustrates a communication system to dynamically implement uplink multi-user multiple input and multiple output format for wireless communication devices.

FIG. 2 illustrates a method of operating an eNodeB to dynamically provide uplink multi-user multiple input and multiple output format to wireless communication devices.

FIG. 3A illustrates an operational scenario of providing multiple input and multiple output format for wireless communication devices.

FIG. 3B illustrates an operational scenario of providing multiple input and multiple output format for wireless communication devices.

FIG. 4 illustrates a chart demonstrating the allocation of resource blocks to wireless communication devices.

FIG. 5 illustrates a chart demonstrating the allocation of resource blocks to wireless communication devices.

FIG. 6 illustrates an eNodeB computing system to dynamically provide uplink multi-user multiple input and multiple output format to wireless communication devices.

### DETAILED DESCRIPTION

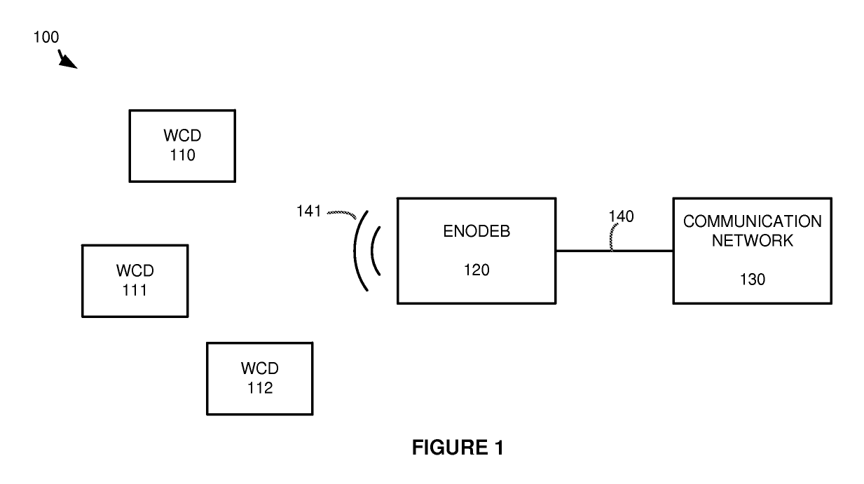

FIG. 1 illustrates a communication system 100 to dynamically implement uplink multi-user multiple input and multiple output (MIMO) format for wireless communication devices. Communication system 100 includes wireless communication devices (WCDs) 110-112, eNodeB 120, and communication network 130. Communication network 130 includes various networking nodes, end user devices, service nodes, or other similar network elements. ENodeB 120 provides Long Term Evolution wireless signaling 141 to WCDs 110-112. ENodeB 120 further communicates with communication network 130 via communication link 140.

In operation, WCDs 110-112 include various applications and processes that require wireless communications with other end user devices, serving systems, or other similar computing systems. To accommodate the communications, eNodeB 120 is provided that is capable of transmitting and receiving data from the wireless devices. In particular, eNodeB 120 is capable of providing MIMO LTE communication format to WCDs 110-112. MIMO is a method of increasing the capacity on a radio link by using multiple transmit antennas and receive antennas to exploit multipath propagation.

Here, eNodeB 120 is capable of providing LTE communications in single user MIMO, as well as multi-user MIMO. Single user MIMO considers a single multi-antenna transmitter communicating with a single multi-antenna receiver. For example, WCD 110 may communicate with eNodeB 120 using a resource block designated to WCD 110 and no other communication devices, wherein the resource block comprise a particular frequency range and time period. In contrast, multi-user MIMO uses space-division multiple access (SDMA) to allow multiple transmitters to send separate signals and multiple receivers to receive separate signals simultaneously in the same band. For example, rather than allocating each WCD of WCDs 110-112 to separate resource blocks, eNodeB 120 may schedule the devices within shared resource blocks to accommodate more devices within the network. Once scheduled and uplink communications are initiated, each of the devices then filters undesired communications for the other the devices within the same resource block. However, although more devices can be accommodated using multi-user MIMO over single user MIMO, power consumption may increase for each of the devices, as transmitting in multi-user MIMO takes more resources with the increase in interference.

To mitigate the effect that multi-user MIMO has on the battery life of the individual devices, eNodeB 120 may dynamically transition between uplink single user MIMO and uplink multi-user MIMO based on the uplink data requirements of the end user devices. Accordingly, when only a few devices are communicating over eNodeB 120, eNodeB 120 may communicate and schedule the devices using single user MIMO format. However, if the data requirements for the devices increase, or the number of devices communicating increase, eNodeB 120 may transition to using multi-user MIMO format to supply the required data to the devices.

In some implementations, the determination of when to transition from single user to multi-user mode may be based on the uplink throughput that can be provided to the end user devices. For example, when devices are near the edge of the coverage area supplied by eNodeB 120, the devices may be provided with a greater throughput using single user mode over multi-user mode. Accordingly, based on the average throughput that can be supplied to the various WCDs, eNodeB 120 may transition between single user and multi-user mode for the uplink communications.

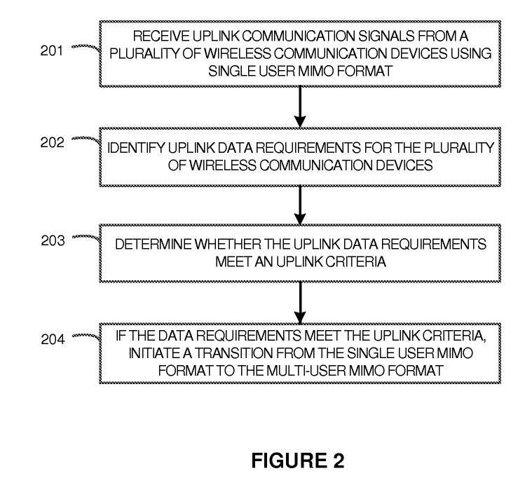

FIG. 2 illustrates a method of operating eNodeB 120 to dynamically provide uplink multi-user MIMO format to wireless communication devices. As described previously, applications and processes executing on WCDs 110-112 may require communications with other end user devices, servers, and other computing systems within communication network 130. To provide the communications, eNodeB 120 receives uplink communication signals from a plurality of WCDs 110-112 using single user MIMO format (201). Single user MIMO format allows devices to conserve battery power and limits the amount of interference between the communications of the devices. For example, the uplink communication for WCD 110 may be scheduled in separate and distinct resource blocks than the uplink communication from WCD 111. This allows the devices to use less transmit power than would be required if the devices were scheduled in overlapping resource blocks.

During the communication, eNodeB 120 identifies uplink data requirements for the plurality of WCDs 110-112 (202). These data uplink requirements may be based on the number of devices communicating with eNodeB 120, may be based on the amount of data waiting to be transmitted to eNodeB 120, may be based on the types of applications executing on the devices, may be based on the average expected throughput for the devices, or may be based on any other similar data uplink information, including combinations thereof. Once the uplink data requirements are determined, eNodeB 120 may determine whether the uplink data requirements meet an uplink criteria (203). In some examples, the uplink criteria may comprise a predefined number of communicating devices, an amount of data that needs to be transmitted by the communicating devices, or some other criteria that can be compared with the current state of the communication system.

In some implementations, eNodeB 120 may maintain records of the average throughputs that can be supplied using both single user MIMO and multi-user MIMO, and use these results to determine when to transition the communication format for the devices. Accordingly, based on previous throughputs that were supplied to WCDs, eNodeB 120 may determine when the communication format should be transitioned to multi-user MIMO format. For example, once all three of WCDs 110-112 require an uplink for a large quantity of data, eNodeB 120 may determine when the devices would be provided with a greater throughput using multi-user MIMO over single user MIMO.

If the data requirements meet the uplink criteria, eNodeB 120 initiates a transition from the single user MIMO format to the multi-user MIMO format (204). By transitioning the uplink communications to multi-user MIMO format, eNodeB 120 may allocate resource blocks to multiple WCDs, allowing increased uplink spectrum efficiency and capacity. In particular, rather than allocating individual blocks to each communication for the devices, eNodeB 120 may require devices to share resource blocks to more efficiently allocate the available frequency space.

Although illustrated in the example of FIG. 2 as changing from single user MIMO to multi-user MIMO, it should be understood that the process might also be reversed to transition from multi-user MIMO to single user MIMO. As described previously, multi-user MIMO may cause decreased throughput in some examples, and an increase in battery usage for the individual WCDs. This increase is due to the increase in transmit power that is required by the devices to overcome the uplink interference that occurs when multiple devices communicate in the same resource blocks. To remedy the problem, eNodeB 120 may monitor the data requirements for the connecting devices to determine when the devices meet a subsequent criteria to transition from using multi-user MIMO to using single user MIMO. Similar to the operations described above with step 202, eNodeB 120 may monitor information about the amount of data waiting to be transmitted from the devices, the number of devices currently communicating with the eNodeB, the current throughput that is being provided to each of the devices, or any other similar information, including combinations thereof. Once eNodeB 120 identifies the subsequent criteria, eNodeB 120 may initiate the transition back to single user MIMO format. By only applying multi-user MIMO when connecting devices require it, battery for the devices may be conserved by limiting the amount of transmission power required to communicate data.

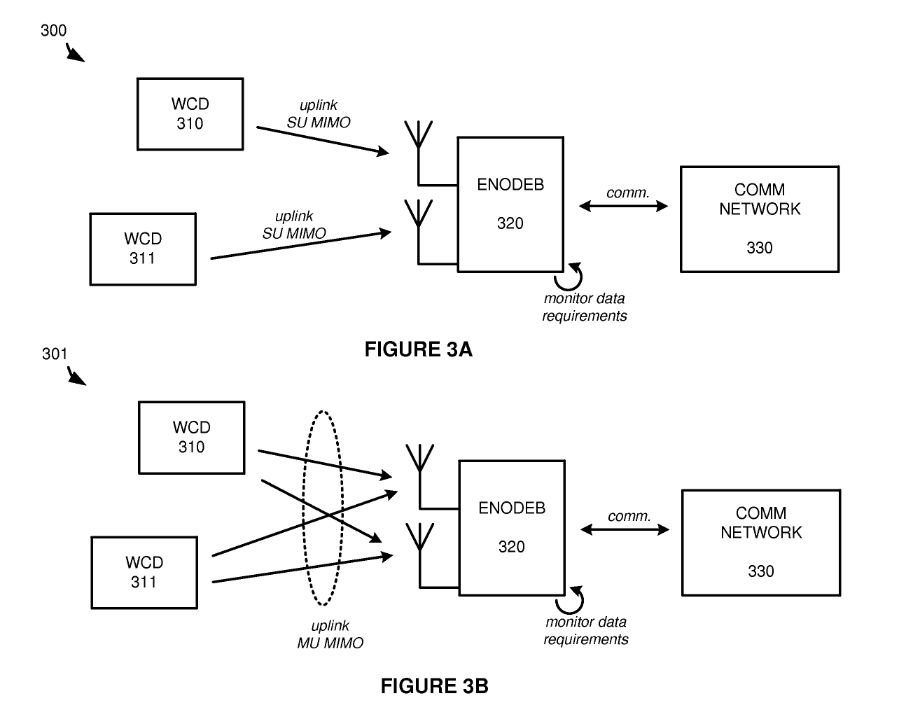

FIGS. 3A and 3B illustrate operational scenarios 300-301 of providing multiple input and multiple output format for wireless communication devices. FIGS. 3A and 3B include WCDs 310-311, eNodeB 320, and communication network 330. ENodeB 320 communicates with communication network 330 to provide wireless communication services to WCDs 310-311. In particular, eNodeB 320 provides LTE MIMO signaling to WCDs 310-311 using multiple antennas.

As depicted in operational scenario 300, WCDs 310-311 transmit or uplink data to eNodeB 310 using single-user MIMO format. Single user format allocates separate resource blocks for each of the communicating devices. For example, WCD 310 may transmit in resource blocks for a first frequency, while WCD 311 may transmit in resource blocks for a second frequency. While this MIMO configuration may provide the most throughput when there are a limited amount of uplink communications, as more communications are required, eNodeB 320 may attempt to provide higher spectrum capacity and efficiency. In at least one example, eNodeB 320 may monitor the data requirements for the connecting wireless devices. These data requirements may include the amount of data that is pending to be transmitted, the number of devices that are now communicating with the eNodeB, the average amount of throughput that is being supplied to the devices, or any other similar information.

Based on the data requirements identified for the communications, eNodeB 320 may initiate a transition from using single user MIMO format to using multi-user MIMO format. This transition may include a scheduling change that allows multiple devices to be allocated to the same resource blocks. Thus, rather than allowing the devices to communicate with individual resources, the devices may share frequency and time domain resources for their respective uplink communications.

Referring to operational scenario 301 in FIG. 3B as an example of transitioning from single user format to multi-user format, WCDs 310-311 are no longer required to be scheduled in separate resource blocks for uplink communication. In particular, operational scenario 301 demonstrates an example of sharing resource blocks between uplink communications for WCDs 310 and 311. This multiplexing or sharing of communication frequencies allows WCDs 310 and 311 to share frequencies over the same time period, at the expensive of higher battery usage and interference between the two communications. In particular, eNodeB 320 includes two antennas in the present example configured to provide two frequency components, which can be shared by WCDs 310-311 during multi-user MIMO.

In addition to the transition from single user MIMO to multi-user MIMO, eNodeB 320 is further configured to identify when the capacity provided by multi-user MIMO is no longer required. By identifying second criteria for the data requirements, eNodeB 320 may only implement multi-user MIMO when connecting devices require it, limiting the amount of uplink interference and battery that is consumed by the devices during the communication. Accordingly, eNodeB 320 may continue to monitor the various characteristics for the uplink devices, including the amount of data that is still required to be transferred, the amount of devices that require an uplink for data, the amount of throughput that is being provided using multi-user MIMO over single user MIMO, or any other similar information. Once the information meets the second criteria to drop to single user MIMO, eNodeB 320 may initiate a scheduling process using the single user MIMO format.

In some implementations, eNodeB 320 may implement a delay to eliminate quick transitions between single user and multi-user MIMO configurations. For example, when an uplink criteria is met to transition from the single user configuration to the multi-user configuration, it may be inefficient to quickly drop the configuration back to single user MIMO. Accordingly, eNodeB 320 may implement a wait period that prevents another MIMO transition within a certain time period. Once the time period expires, eNodeB 320 may determine if the uplink data requirements for the WCDs meet a criteria to transition the device.

Although illustrated in the present example with two devices, it should be understood that any number of WCDs might trigger the transition from single user MIMO to multi-user MIMO. Further, although two antennas are illustrated with the eNodeB, it should be understood that any number of antennas might be included on the eNodeB. These additional antennas may be used to provide different frequencies and additional resource blocks to connecting WCDs.

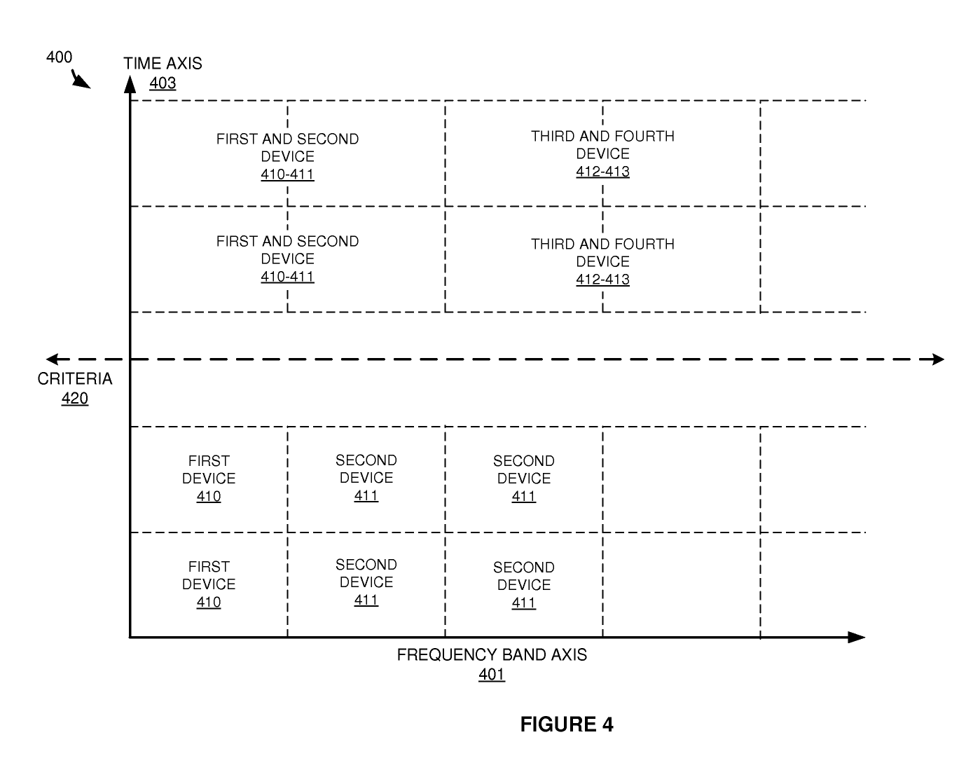

FIG. 4 illustrates a chart 400 demonstrating the allocation of resource blocks to WCDs according to one implementation. Chart 400 includes frequency band axis 401 and time axis 403. Within chart 400 resource blocks are illustrated, which comprise a particular frequency range and time period. Chart 400 is an example of allocating resource blocks to connecting WCDs based on the current MIMO configuration for an eNodeB. In particular, chart 400 demonstrates an initial allocation of resource blocks using single user MIMO, before transitioning to allocating resource blocks using a multi-user MIMO.

As illustrated in FIG. 4, the eNodeB allocates uplink resource blocks to first device 410 and second device 411 using single user MIMO. Single user MIMO allows each of the devices to conserve power consumption by limiting the amount of interference between each of the devices during communication. For example, first device 410 is provided a single resource block per time period within chart 400, while second device 411 is provided with two resource blocks for each time period within chart 400.

Over time, the eNodeB is configured to monitor the data requirements of connecting wireless communication devices. These data requirement may include the amount of data that is pending to be transmitted from each of the devices, the amount of throughput required for each of the devices, the number of devices that currently require uplink communications from the eNodeB, or any other similar uplink information. Based on the information, the eNodeB determines if the data requirements meet criteria 420. Once the requirements meet criteria 420, the eNodeB transitions from using single user MIMO to multi-user MIMO.

Referring still to FIG. 4, four devices 410-413 are communicating with the eNodeB and require uplink communications. Because the uplink communication requirements meet criteria 420, the eNodeB transitions to using multi-user MIMO. In particular, the eNodeB schedules devices 410-413 in the same resource blocks, which, at the expense of higher interference, allows for greater spectrum efficiency and capacity for the connecting devices. Here, the eNodeB schedules two resource blocks for first and second devices 410-411, and schedules a separate set of two resource blocks for third and fourth devices 412-413. Accordingly, rather than allocating individual resource blocks to the connecting devices, devices may share resource blocks to more efficiently allocate the spectrum available to the wireless provider.

In some implementations, to determine criteria 420, the eNodeB may use predicted data throughput for the devices. For example, the eNodeB may maintain records of the average throughput using single and multi-user MIMO. Based on the throughput records, the eNodeB may identify when multi-user MIMO provides a higher throughput to the devices than single user MIMO. In some instances, the eNodeB may predict single user and multi-user MIMO throughput for each of the devices based on the number of devices connected, the distance of the devices from the eNodeB, the amount of data that needs to be transmitted, or a variety of other factors for the predicted throughput. Once the throughputs are predicted, the predictions may be compared to criteria for transitioning from single user to multi-user MIMO.

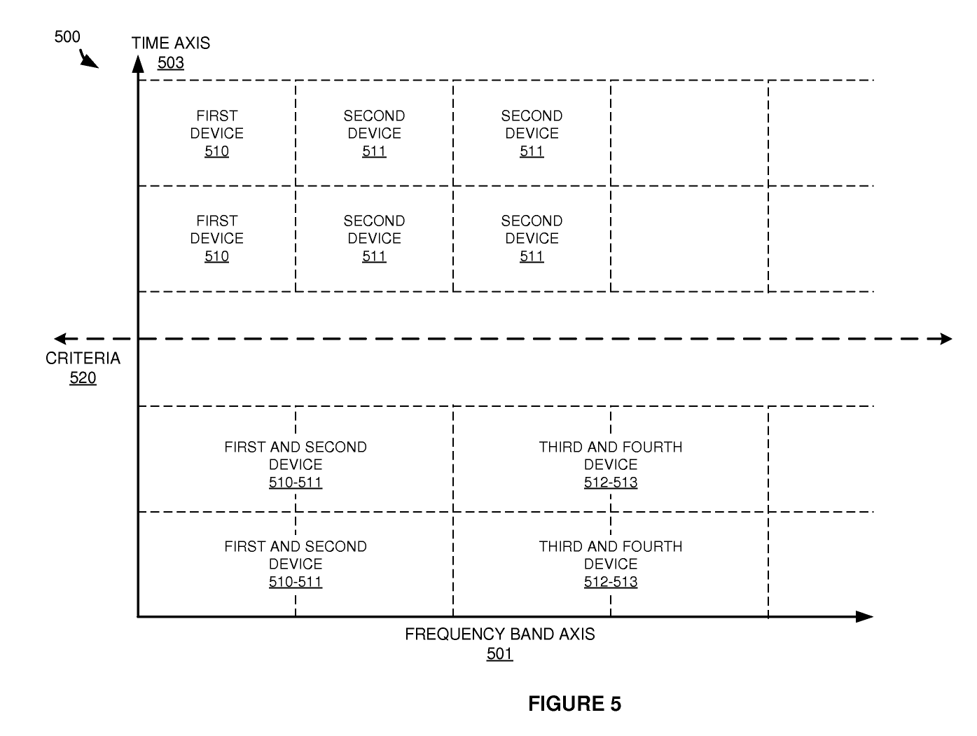

FIG. 5 illustrates a chart 500 demonstrating the allocation of resource blocks to WCDs. Chart 500 includes similar axis to chart 400 of FIG. 4, including frequency band axis 501 and time axis 503. In the present example, chart 500 is representative of a transition from multi-user MIMO format to single user MIMO format. In operation, an eNodeB may be configured to transition from single user to multi-user MIMO uplink communication only when it is required for requested communications. This transitioning as required allows battery to be conserved on the individual devices and limits the amount of uplink interference that occurs using multi-user MIMO.

As depicted, the eNodeB allocates two resource blocks per time period to first and second devices 510-511, and allocates another set of two resource blocks per time period to third and fourth devices 512-513. This sharing of resource blocks between the devices allows the devices to more efficiently use the available spectrum available to the eNodeB. While providing the uplink communications to the WCDs, the eNodeB also identifies when the devices meet an uplink criteria 520. The uplink criteria may be based on the number of devices communicating, the amount of data that is pending to be transmitted from the WCDs, the physical proximity of the WCDs and the eNodeB, the throughput required by the WCDs, or any other similar uplink requirement data. In some implementations, the eNodeB may predict the average throughput in both single user and multi-user MIMO for the individual devices to determine when to transition the devices between the MIMO configurations.

Here, once criteria 520 is met, the eNodeB transitions from allocating shared resource blocks to the devices to individual resource blocks for each of the devices. In the illustrated example of FIG. 5, first device 510 is allocated a single resource block per time period, whereas second device 511 is allocated two resource blocks per time period. This transition from multi-user format to single user format may allow the devices to limit the amount of battery used on uplink communications, and limit the amount of interference that occurs between the device communications.

Although illustrated in the examples in FIGS. 1-5 using uplinks in LTE communication format, it should be understood that similar principles might be applied to other MIMO wireless formats. For example, it may be desirable to save battery resources on wireless devices while the devices are communicating via Wi-Fi format.

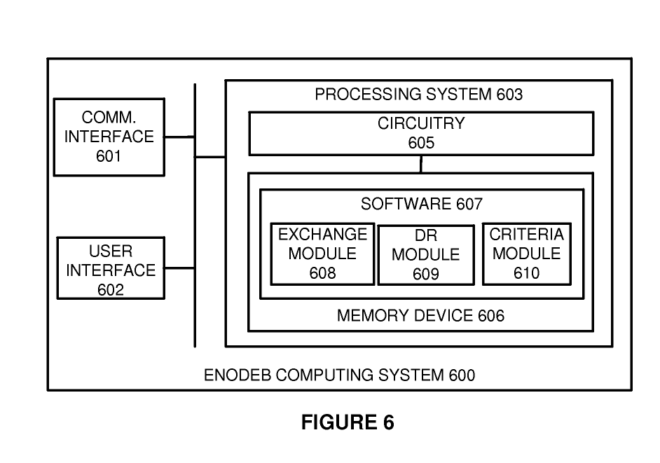

FIG. 6 illustrates an eNodeB computing system 600 to dynamically provide uplink multi-user multiple input and multiple output format to wireless communication devices. ENodeB computing system 600 is representative of any computing system or systems with which the various operational architectures, processes, scenarios, and sequences disclosed herein for an eNodeB may be implemented. ENodeB computing system 600 is an example of eNodeB 120 and eNodeB 320, although other examples may exist. ENodeB computing system 600 comprises communication interface 601, user interface 602, and processing system 603. Processing system 603 is linked to communication interface 601 and user interface 602. Processing system 603 includes processing circuitry 605 and memory device 606 that stores operating software 607. ENodeB computing system 600 may include other well-known components such as a battery and enclosure that are not shown for clarity. Computing system 600 may be a personal computer, server, or some other computing apparatus—including combinations thereof.

Communication interface 601 comprises components that communicate over communication links, such as network cards, ports, radio frequency (RF) transceivers, processing circuitry and software, or some other communication devices. Communication interface 601 may be configured to communicate over metallic, wireless, or optical links. Communication interface 601 may be configured to use Time Division Multiplex (TDM), Internet Protocol (IP), Ethernet, optical networking, wireless protocols such as LTE, communication signaling, or some other communication format—including combinations thereof. Communication interface 601 is configured to provide LTE communication format to WCDs that require access to the wireless network. Communication interface 601 is further configured to communicate with gateways and other access nodes of the wireless network that connect to the Internet and other packet data networks.

User interface 602 comprises components that interact with a user to receive user inputs and to present media and/or information. User interface 602 may include a speaker, microphone, buttons, lights, display screen, touch screen, touch pad, scroll wheel, communication port, or some other user input/output apparatus—including combinations thereof. User interface 602 may be omitted in some examples.

Processing circuitry 605 comprises microprocessor and other circuitry that retrieves and executes operating software 607 from memory device 606. Memory device 606 comprises a non-transitory storage medium, such as a disk drive, flash drive, data storage circuitry, or some other memory apparatus. Processing circuitry 605 is typically mounted on a circuit board that may also hold memory device 606 and portions of communication interface 601 and user interface 602. Operating software 607 comprises computer programs, firmware, or some other form of machine-readable processing instructions. Operating software 607 includes exchange module 608, data requirements (DR) module 609, and criteria module 610, although any number of software modules may provide the same operation. Operating software 607 may further include an operating system, utilities, drivers, network interfaces, applications, or some other type of software. When executed by processing circuitry 605, operating software 607 directs processing system 603 to operate eNodeB computing system 600 as described herein.

In particular, exchange module 608 directs processing system 603 to exchange first uplink communications with WCDs using single user MIMO format. Single user MIMO format allows computing system 600 to allocate individual resource blocks to requesting end user devices. While exchanging first uplink signals with the WCDs, DR module 609 directs processing system 603 to determine uplink data requirements for the WCDs. These uplink data requirements may include the number of devices that require uplink communications, the location of the devices in proximity to computing system 600, the amount of pending data that is required for uplink communications, the amount of throughput that is required by the WCDs, or any other similar requirement information, including combinations thereof. Based on the data requirements, criteria module 610 directs processing system 603 to identify if and when the uplink data requirements meet an uplink criteria. For example, based on the number of devices communicating and the proximity of the devices, computing system 600 may determine that a change should be made to multi-user MIMO format. Once the data requirements meet the uplink criteria, criteria module 610 further directs processing system 603 to transition to using multi-user MIMO format in place of single user MIMO format. Specifically, multi-user MIMO format allows eNodeB computing system 600 to allocate resource blocks to multiple devices to more efficiently use the spectrum available to the wireless provider. Once transitioned, exchange module 608 may exchange second uplink communications with the WCDs using the multi-user MIMO format.

In some implementations, criteria module 610 may use predicted and previously measured throughput values to determine when to transition from single user format to multi-user format. For example, eNodeB computing system 600 may determine predicted average throughputs for the WCDs in both single user MIMO and multi-user MIMO. Based on the predicted throughputs meeting a predefined criteria, computing system 600 may transition to using multi-user MIMO.

Although described above as transitioning from single user MIMO to multi-user MIMO, it should be understood that similar processes might be used to transition from multi-user MIMO back to single user MIMO. Accordingly, DR module 609 may monitor the data requirement information for the connecting WCDs, and criteria module 610 may transition to single user MIMO when a second criteria is met.

Returning to the elements of FIG. 1, WCDs 110-112 comprise Radio Frequency (RF) communication circuitry and an antenna. The RF communication circuitry typically includes an amplifier, filter, modulator, and signal processing circuitry. WCDs 110-112 may also include a user interface, memory device, software, processing circuitry, or some other communication components. WCD 110-112 may each comprise a telephone, computer, e-book, mobile Internet appliance, wireless network interface card, media player, game console, or some other wireless communication apparatus, including combinations thereof.

ENodeB 120 comprises RF communication circuitry and at least one antenna to provide Long Term Evolution (LTE) wireless communications. The RF communication circuitry typically includes an amplifier, filter, RF modulator, and signal processing circuitry. ENodeB 120 may also comprise a router, server, memory device, software, processing circuitry, cabling, power supply, network communication interface, structural support, or some other communication apparatus.

Communication network 130 comprises network elements that provide communication services to WCD 110. Communication network 130 may comprise switches, wireless access nodes, Internet routers, network gateways, application servers, computer systems, communication links, or some other type of communication equipment—including combinations thereof. Communication network 130 may comprise the internet, an LTE wireless communication network, as well as other similar communication networks.

Wireless signaling 141 includes wireless links that use the air or space as transport media, and communicate with WCD 110 using LTE format. Communication link 140 could use various communication protocols, such as Time Division Multiplex (TDM), Internet Protocol (IP), Ethernet, communication signaling, wireless communication signaling, or some other communication format—including combinations thereof. Communication link 140 could be a direct link or may include intermediate networks, systems, or devices.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of operating an eNodeB to dynamically provide multi-user multiple-input and multiple-output (MIMO) format, the method comprising:
receiving uplink communication signals from a plurality of wireless communication devices using single user MIMO format.
identifying uplink data requirements for the plurality of wireless communication devices;
determining whether the uplink data requirements meet an uplink criteria;
if the data requirements meet the uplink criteria, initiating a transition from the single user MIMO format to the multi-user MIMO format.

2. The method of claim 1 further comprising, after the transition from the single user MIMO format to the multi-user MIMO format, receiving second uplink communication signals from the plurality of wireless communication devices using the multi-user MIMO format.

3. The method of claim 1 wherein the uplink data requirements for the plurality of wireless communication devices comprises data waiting to be transmitted for the plurality of wireless communication devices.

4. The method of claim 1 wherein the uplink data requirements for the plurality of wireless communication devices comprises data throughput requirements for the plurality of wireless communication devices.

5. The method of claim 1 wherein the uplink data requirements for the plurality of wireless communication devices comprises a quantity of wireless communication devices requesting uplink communications.

6. The method of claim 1 further comprising:
after the transition from the single user MIMO format to the multi-user MIMO format, identifying supplemental data uplink requirements for the plurality of wireless communication devices;
determining whether the supplemental data uplink requirements meet a second uplink criteria; and
if the supplemental data uplink requirements meet the second uplink criteria, initiating a second transition from the multiuser MIMO format to single user MIMO format.

7. The method of claim 6 wherein, after the transition from the single user MIMO format to the multi-user MIMO format, identifying the supplemental data uplink requirements for the plurality of wireless communication devices comprises after the transition from the single user MIMO format to the multi-user MIMO format and after a predetermined period of time, identifying the supplemental data uplink requirements for the plurality of wireless communication devices.

8. The method of claim 1 wherein determining whether the uplink data requirements meet the uplink criteria comprises:
determining a predicted single user MIMO format throughput based on the uplink data requirements;
determining a predicted multi-user MIMO format throughput based on the uplink data requirements; and
determining whether the predicted single user MIMO format throughput and the predicted multi-user MIMO format throughput meet the uplink criteria.

9. An apparatus to dynamically provide multi-user multiple-input and multiple-output (MIMO) format, the apparatus comprising:
one or more non-transitory computer readable media; and
processing instructions stored on the one or more non-transitory computer readable media that, when executed by a processing system, direct the processing system to;
receive uplink communication signals from a plurality of wireless communication devices using single user MIMO format;
identify uplink data requirements for the plurality of wireless communication devices;
determine whether the uplink data requirements meet an uplink criteria; and
if the data requirements meet the uplink criteria, initiating a transition from the single user MIMO format to the multi-user MIMO format.

10. The apparatus of claim 9 wherein the processing instructions further direct the processing system to, after the transition from the single user MIMO format to the multi-user MIMO format, receive second uplink communication signals from the plurality of wireless communication devices using the multi-user MIMO format.

11. The apparatus of claim 9 wherein the uplink data requirements for the plurality of wireless communication devices comprises data waiting to be transmitted for the plurality of wireless communication devices.

12. The apparatus of claim 9 wherein the uplink data requirements for the plurality of wireless communication devices comprise data throughput requirements for the plurality of wireless communication devices.

13. The apparatus of claim 9 wherein the uplink data requirements for the plurality of wireless communication devices comprises a quantity of wireless communication devices requesting uplink communications.

14. The apparatus of claim 9 wherein the processing instructions further direct the processing system to:
after the transition from the single user MIMO format to the multi-user MIMO format, identify supplemental data uplink requirements for the plurality of wireless communication devices;
determine whether the supplemental data uplink requirements meet a second uplink criteria; and
if the supplemental data uplink requirements meet the second uplink criteria, initiate a second transition from the multi-user MIMO format to the single user MIMO format.

15. The apparatus of claim 14 wherein the processing instructions to, after the transition from the single user MIMO format to the multi-user MIMO format, identify the supplemental data uplink requirements for the plurality of wireless communication devices direct the processing system to, after the transition from the single user MIMO format to the multi-user MIMO format and after a predetermined period of time, identify the supplemental data uplink requirements for the plurality of wireless communication devices.

16. The apparatus of claim 9 wherein the processing instructions to determine whether the uplink data requirements meet the uplink criteria direct the processing system to:
determine a predicted single user MIMO format throughput based on the uplink data requirements;
determine a predicted multi-user MIMO format throughput based on the uplink data requirements; and
determine whether the predicted single user MIMO format throughput and the predicted multi-user MIMO format throughput meet the uplink criteria.

17. An eNodeB to dynamically provide multi-user multiple-input and multiple-output (MIMO) format, the eNodeB comprising:
a communication interface configured to receive uplink communication signals from a plurality of wireless communication devices using single user MIMO format;
a processing system, communicatively coupled to the communication interface, configured to:
identify uplink data requirements for the plurality of wireless communication devices;
determine whether the uplink data requirements meet an uplink criteria; and
if the data requirements meet the uplink criteria, initiating a transition from the single user MIMO format to the multi-user MIMO format; and
the communication interface configured to, after the transition from the single user MIMO format to the multi-user format, receive second uplink communication signals from the plurality of wireless communication devices using the multi-user MIMO format.

18. The eNodeB of claim 17 wherein the processing system configured to determine whether the uplink data requirements meet the uplink criteria direct the processing system to:
determine a predicted single user MIMO format throughput based on the uplink data requirements;
determine a predicted multi-user MIMO format throughput based on the uplink data requirements; and
determine whether the predicted single user MIMO format throughput and the predicted multi-user MIMO format throughput meet the uplink criteria.

19. The eNodeB of claim 17 wherein the processing system is further configured to:
after the transition from the single user MIMO format to the multi-user MIMO format, identify supplemental data uplink requirements for the plurality of wireless communication devices;
determine whether the supplemental data uplink requirements meet a second uplink criteria; and
if the supplemental data uplink requirements meet the second uplink criteria, initiate a second transition from the multi-user MIMO format to the single user MIMO format.

20. The eNodeB of claim 17 wherein the uplink data requirements for the plurality of wireless communication devices comprise at least one of data waiting to be transmitted for the plurality of wireless communication, data throughput requirements for the plurality of wireless communication devices, or a quantity of wireless communication devices requesting uplink communications.
